(19) United States
(12) Patent Application Publication
(10) Pub. No.: US 2007/0104476 A1
(43) Pub. Date: May 10, 2007

(54) Camera system and controller

(75) Inventors: Takeshi Yasutomi, Tokyo (JP); Yoshito Katagiri, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Photo Imaging, Inc., Tokyo (JP)

(21) Appl. No.: 11/590,347

(22) Filed: Oct. 30, 2006

(30) Foreign Application Priority Data
Nov. 4, 2005 (JP) JP2005-320584

(51) Int. Cl. G03B 17/18

(52) U.S. Cl. 396/287

(57) ABSTRACT

A camera system to photograph a subject as a preview photography and as a regular photography, and to display image of the preview photography and image of the regular photography, including: a communication section; a photographing section to photograph the subject; a control section to control the photographing section through the communication section, at least to photograph the subject as the preview photography; a memory section to store image data as the regular photography and as the preview photography of the subject, photographed by the photographing section; and an image display section, provided on the control section, wherein when the control section controls the photographing section to photograph the subject as the regular photography after the preview photography, the image display section displays the preview photography of the subject based on the image data which was previously stored in the memory section.

This application is based on Japanese Patent Application No. 2005-320584 filed on Nov. 4, 2005 in the Japanese Patent Office, the entire content of which is hereby incorporated by reference.

### TECHNICAL FIELD

The present invention relates to a camera system and a controller.

### BACKGROUND

There has been known a camera system wherein a photographing apparatus such as a digital camera and a controller such as a personal computer that controls the photographing apparatus are connected through a prescribed communication means.

In the camera system of this kind, an image is taken by the photographing apparatus pursuant to the control command from the controller, for example, and image data of the image thus taken are transferred to the controller. Then, the controller displays an image based on the image data transferred from the photographing apparatus, for example.

In recent years, it has become a problem that transfer of image data from the photographing apparatus to the controller is time-consuming, and transmission of control command to the photographing apparatus from the controller cannot be carried out instantly, because an amount of image data has been increased with a trend toward higher pixels of the photographing apparatus. Under the aforesaid background, there is proposed a camera system wherein a communication path for the transfer of image data is different from that for the transmission of control command, so that control command may be transmitted from the controller, for example, even when image data are transferred from the photographing apparatus (for example, see Patent Document 1).

[Patent Document 1] Unexamined Japanese Patent Application Publication No. 2001-268424

Incidentally, on a photographing apparatus such as a digital camera, there is provided an after-view function so that a user can confirm the image taken regularly by the photographing apparatus, after the regular photographing.

Even in the camera system mentioned above, there still is a demand to confirm the image taken by the photographing apparatus regularly, with the after-view function, on the controller side. However, transfer of image data from the photographing apparatus to the controller is time-consuming, which makes a period up to after-view to be long, and makes it impossible to confirm instantly the image taken regularly, resulting in a problem of inconvenience for a user.

### SUMMARY

An objective of the invention is to provide a camera system and a controller wherein, when confirming an image taken by a photographing apparatus, the image can be confirmed rapidly, and the ease of use is improved for a user.

For solving the aforesaid problems, the invention described in Item 1 is a camera system in which a photographing apparatus and a controller having a display means are connected to each other through a communication means, and the photographing apparatus conducts at least preview image photographing and regular image photographing based on an instruction from the controller, and the controller displays, on the display means, image data obtained through photographing by the photographing apparatus, wherein the camera system is provided with a memory means that stores image data obtained through photographing by the photographing apparatus, and the photographing apparatus conducts preview image photographing based on an instruction for preview image photographing coming from the controller and conducts regular image photographing based on an instruction for regular image photographing coming from the controller, while, the controller displays preview image data obtained through the preview image photographing on the display means, when an instruction for preview image photographing is given to the photographing apparatus, and displays preview image data obtained in advance on the display means when an instruction for regular image photographing is given to the photographing apparatus, and the memory means stores regular image data obtained through regular image photographing by the photographing apparatus.

The invention described in Item 2 is the camera system according to Item 1, wherein the memory means is provided on the photographing apparatus.

The invention described in Item 3 is the camera system according to Item 1, wherein the memory means is provided on the controller.

The invention described in Item 4 is the camera system according to any one of Items 1-3, wherein, when regular image data by the regular image photographing are obtained from the photographing apparatus in the case where an instruction for regular image photographing is given to the photographing apparatus by the controller, preview image data obtained in advance are changed to the obtained regular image data to be displayed on the display means.

The invention described in Item 5 is the camera system according to Item 4, wherein, when displaying the regular image data on the display means, the controller displays that the displayed image data are regular image data through the prescribed display mode, when displaying the regular image data on the display means.

The invention described in Item 6 is a camera system in which a photographing apparatus and a controller having a display means are connected to each other through a communication means, and the photographing apparatus conducts at least preview image photographing and regular image photographing based on an instruction from the controller, and the controller displays, on the display means, image data obtained through photographing by the photographing apparatus, wherein the camera system is provided with a memory means that stores image data obtained through photographing by the photographing apparatus, and the photographing apparatus conducts preview image photographing based on an instruction for preview image photographing coming from the controller and conducts regular image photographing based on an instruction for regular image photographing coming from the controller, to generate from the regular image data obtained through the regular image photographing the low resolution image data whose resolution is lower than that of the regular image data, and the controller displays, on the display means, preview image data obtained through the preview image photographing, when an instruction for preview image photographing is given to the photographing apparatus, and displays, on the display means, low resolution image data obtained through the regular image photographing, when an instruction for regular image photographing is given to the photographing apparatus, while, the memory means stores regular image data obtained through regular image photographing by the photographing apparatus.

The invention described in Item 7 is the camera system according to Item 6, wherein, when displaying the low resolution image data on the display means, the controller displays, through the prescribed display mode, that the displayed low resolution image data are those generated from regular image data.

The invention described in Item 8 is a controller that is connected with a photographing apparatus through a communication means to give at least an instruction for preview image photographing and an instruction for regular image photographing to the photographing apparatus and to display, on a display means, image data obtained through photographing by the photographing apparatus, wherein when an instruction for preview image photographing is given to the photographing apparatus, preview image data obtained through the preview image photographing are displayed on the display means, while, when an instruction for regular image photographing is given to the photographing apparatus, preview image data obtained in advance are displayed on the display means.

The invention described in Item 9 is the controller according to Item 8, wherein a memory means to store regular image data obtained through regular image photographing by the photographing apparatus is provided.

The invention described in Item 10 is the controller according to Item 8 or Item 9, wherein when regular image data by the regular image photographing are obtained from the photographing apparatus in the case where an instruction for regular image photographing is given to the photographing apparatus, preview image data obtained in advance is changed to the obtained regular image data to be displayed on the display means.

The invention described in Item 11 is the controller according to Item 10, wherein, when displaying the regular image data on the display means, the controller displays, through the prescribed display mode, that the displayed image data are regular image data.

The invention described in Item 12 is a controller that is connected with a photographing apparatus that conducts preview image photographing and regular image photographing and generates low resolution image data whose resolution is lower than that of the regular image data from regular image data obtained through the regular image photographing through a communication means to give at least an instruction for preview image photographing and an instruction for regular image photographing to the photographing apparatus and to display, on a display means, image data obtained through photographing by the photographing apparatus, wherein when an instruction for preview image photographing is given to the photographing apparatus, preview image data obtained through the preview image photographing are displayed on the display means, while, when an instruction for regular image photographing is given to the photographing apparatus, low resolution image data generated from regular image data obtained through the regular image photographing are displayed on the display means.

The invention described in Item 13 is the controller according to Item 12, wherein, when displaying the low resolution image data on the display means, the controller displays, through the prescribed display mode, that the displayed low resolution image data are those generated from regular image data.

Concerning the effects of the invention, in the inventions described in Items 1, 2 and 8, when an instruction for regular image photographing is given, preview image data obtained in advance can be displayed on the display means. That is to say, when an instruction for regular image photographing is given, preview image data obtained immediately before the instruction can be displayed on the display means. Therefore, an image that can be confirmed on the controller side is not a regular image itself, but it is one which is substantially the same as the regular image. Thus, an effect which is substantially the same as that in the case of confirming the regular image itself can be obtained, and when confirming the image taken by the photographing apparatus on the controller side, the confirmation can be carried out rapidly, which is convenient for a user.

In the inventions described in Items 3 and 9, it is naturally possible to obtain an effect which is the same as that in the inventions described in Items 1 and 8, and it is also possible to store regular image data on the controller side, thus, it is easy to conduct processing such as editing of the regular image data, which is convenient for a user.

In the inventions described in Items 4 and 10, it is naturally possible to obtain an effect which is the same as that in any one of the inventions described in Items 1-3 and 8 or 9, and it is also possible to change image data to be displayed on the display means from preview image data obtained in advance to the obtained regular image data when the regular image data are obtained. Therefore, the regular image itself can also be confirmed, resulting in rapid and accurate confirmation, which is more convenient for a user.

In the inventions described in Items 5 and 11, it is naturally possible to obtain an effect which is the same as that in the inventions Items 4 and 10, and it is also possible to display that the displayed image data are regular image data, when image data to be displayed on the display means are changed to regular image data. Therefore, it is possible to judge surely whether the image data displayed on the display means are preview image data or the image data displayed on the display means are regular image data, which is favorable for a user.

In the inventions described in Items 6 and 12, when an instruction for regular image photographing is given, low resolution image data of the regular image generated on the photographing apparatus side can be displayed on the display means. Namely, since low resolution image data of regular image to be displayed on the display means are less in terms of data amount than regular image data, it is possible to display more rapidly than regular image data, and when confirming images taken by the photographing apparatus on the controller side, the confirmation can be carried out rapidly, which is convenient for a user.

In the inventions described in Items 7 and 13, it is naturally possible to obtain an effect which is the same as that in the inventions described in Items 6 and 12, and it is also possible to display that the image data are those generated from regular image data, when displaying low resolution image data of regular image on the display means. Therefore, it is possible to judge surely whether the image data displayed on the display means are preview image data or data generated from regular image data, which is favorable for a user.

### BRIEF DESCRIPTION OF THE DRAWINGS

FIG. 1 is a block diagram showing a functional structure of a camera system in the first embodiment.

FIG. 2 is a flow chart for illustrating the first processing by a camera system in the first embodiment.

FIG. 3 is a flow chart for illustrating the second processing by a camera system in the first embodiment.

FIG. 4 is a diagram showing a photographing control screen.

FIG. 5 is a flow chart for illustrating the processing concerning preview image photographing by a camera system in the first embodiment.

FIG. 6 is a flow chart for illustrating the processing concerning regular image photographing by a camera system in the first embodiment.

FIG. 7 is a block diagram showing a functional structure of a camera system in the second embodiment.

FIG. 8 is a flow chart for illustrating the processing concerning regular image photographing by a camera system in the second embodiment.

FIG. 9 is a block diagram showing a functional structure of a camera system in the third embodiment.

FIG. 10 is a flow chart for illustrating the processing concerning regular image photographing by a camera system in the third embodiment.

### DETAILED DESCRIPTION OF THE PREFERRED EMBODIMENTS

Preferred embodiments of the camera system relating to the invention will be explained in detail as follows, referring to the drawings. Incidentally, a range of the invention is not limited to the illustrations.

### First Embodiment

First, camera system 1 in the First Embodiment will be explained.

<Structure of Camera System>

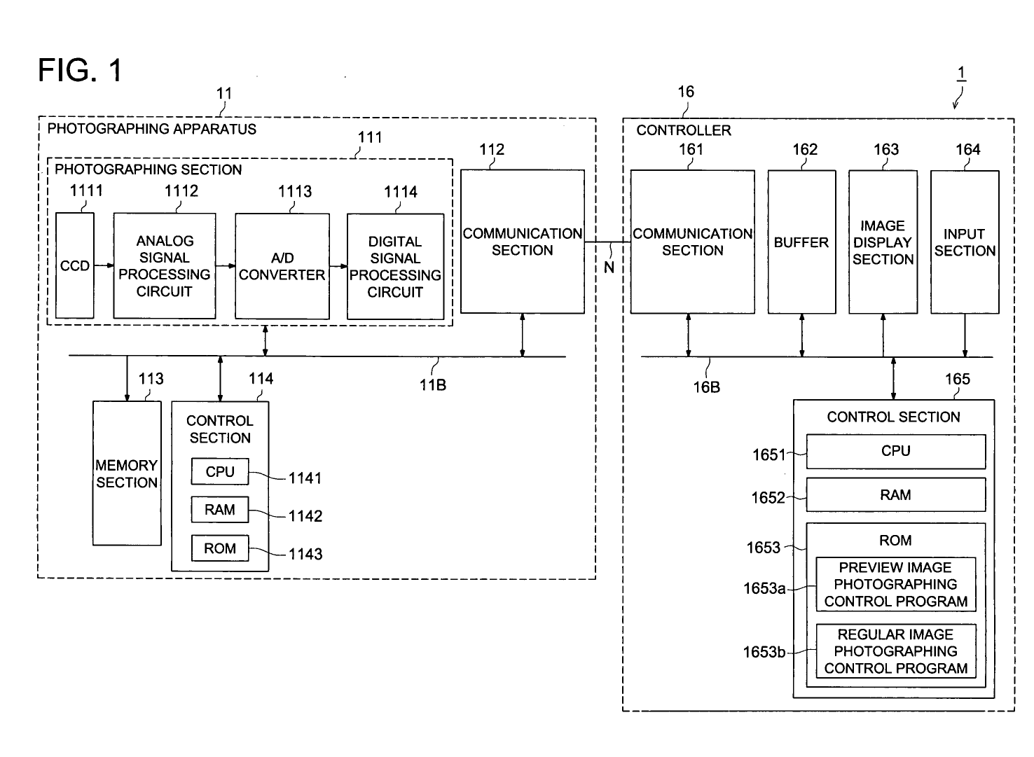

First, the structure of camera system 1 will be explained by reference to FIG. 1.

The camera system 1 is one to be used as, for example, a security camera system and a camera system for taking an identification photograph, and it is composed of photographing apparatus 11 and controller 16 which are connected to each other through communication network N as a communication means, as shown in, for example, FIG. 1.

The photographing apparatus 11 is, for example, a digital camera, and the controller 16 is, for example, a personal computer.

The communication network N is, for example, a communication network such as an Internet, LAN (Local Area Network), WAN (Wide Area Network), and it includes various communication lines such as telephone line network, ISDN (Integrated Services Digital Network) line network, broadband communication line network, private lines, mobile object communication network, communication satellite lines, CATV (Community Antenna TeleVision) line network, optical communication lines and radio communication lines and Internet service provider.

<Structure of Photographing Apparatus>

Photographing apparatus 11 is composed, for example, of photographing section 111, communication section 112, memory section 113 and control section 114, as shown in FIG. 1. Respective sections are connected to each other through bus 11B.

The photographing apparatus 11 conducts at least preview image photographing and regular image photographing, based on an instruction from controller 16.

As shown in FIG. 1, the photographing section 111 is composed, for example, of CCD (Charge Coupled Device) that acquires analog signals by converting photoelectrically light entering through a lens (not shown), analog signal processing circuit 1112 that conducts processing such as CDS (Correlated Double Sampling) or AGC (Automatic Gain Control) for analog signals acquired by CCD 1111, A/D converter 1113 that converts analog signals processed by the analog signal processing circuit 1112 into digital signals and digital signal processing circuit 1114 that conducts processing such as preparation of luminance signal and color difference signal or gamma correction for digital signals acquired through conversion by the A/D converter 1113, and conducts photographing for a prescribed image in accordance with an instruction from the control section 114.

Specifically, the photographing section 111 conducts, for example, preview image photographing in accordance with an instruction from the control section 114 based on an instruction for preview image photographing coming from the controller 16 (for example, “preview image photographing” command), and conducts regular image photographing in accordance with an instruction from the control section 114 based on an instruction for regular image photographing coming from the controller 16 (for example, “regular image photographing” command).

In this case, the preview image means, for example, an image to be taken in by the photographing section 111 sequentially.

Meanwhile, the regular image means, for example, an image to be taken in by the photographing section 111 when an instruction for regular photographing is given by a user through the controller 16. An amount of regular image data is greater than that of preview image data, because image quality of the regular image is higher than that of the preview image.

The communication section 112 is connected with, for example, communication section 161 (described later) of the controller 16 through communication network N, and conducts transmitting and receiving for various types of information between itself and the controller 16.

Specifically, the communication section 112 receives a prescribed control command coming from the controller 16.

Further, the communication section 112 transfers, to the controller 16, preview image data obtained by preview image photographing by photographing section 111, in accordance with, for example, an instruction from control section 114 that is based on “preview image photographing” command coming from the controller 16, and transfers, to the controller 16, regular image data obtained by regular image photographing by photographing section 111, in accordance with an instruction from control section 114 that is based on “regular image photographing” command coming from the controller 16.

The memory section 113 is compose, for example, of a magnetic memory medium, an optical memory medium or of a semiconductor memory.

The memory section 113 stores regular image data obtained through regular image photographing by photographing section 111, in accordance with an instruction from control section 114 that is based on “regular image photographing” command from the controller 16, as, for example, of a memory means.

As shown in FIG. 1, the control section 114 is provided, for example, with CPU (Central Processing Unit) 1141, RAM (Random Access Memory) 1142 and ROM (Read Only Memory) 1143, and controls total photographing apparatus 11 so that the photographing apparatus 11 may operate in accordance with a prescribed control command coming from the controller 16.

CPU 1141 conducts various control operations in accordance with various types of processing programs for photographing apparatus 11 stored in ROM 1143.

RAM 1142 is provided with program storage area for developing processing programs practiced by CPU 1141 and with data storage area for storing processing results which are produced when inputted data or the aforesaid processing programs are practiced.

ROM 1143 stores system programs practicable in photographing apparatus 11, processing programs in various types practicable in the aforesaid system programs, data used in practicing the aforesaid processing programs in various types and data of results of processing subjected to arithmetic processing by CPU 1141. Meanwhile, programs are stored in ROM 1143 in a form of a program code that can be read by a computer.

<Structure of Controller>

As shown in FIG. 1, the controller 16 is provided with, for example, communication section 161, buffer 162, image display section 163, input section 164 and control section 165. Respective sections are connected to each other through bus 16B.

The communication section 161 is connected with, for example, communication section 112 of photographing apparatus 11 through communication network N, and conducts transmitting and receiving for various types of information between itself and the photographing apparatus 11.

Specifically, the communication section 161 transmits a prescribed control command to photographing apparatus 11 in accordance with, for example, an instruction coming from the control section 165.

Further, communication section 161 receives preview image data or regular image data transferred from, for example, photographing apparatus 11.

Buffer 162 stores temporarily preview image data obtained by preview image photographing of photographing apparatus 11, in accordance with an instruction coming, for example, from control section 165.

Image display section 163 is a monitor or the like provided with an unillustrated display screen such as of a liquid crystal type, and it conducts given display processing in accordance with an instruction coming from control section 165.

To be concrete, the image display section 163 displays preview image data obtained by preview image photographing of photographing apparatus 11 or regular image data obtained by regular image photographing of photographing apparatus 11, in accordance with an instruction from control section 165, as, for example. a display means.

Input section 164 is composed of, for example, a cursor key, an alphanumeric key and various functions keys, and it outputs on control section 165 pressed signals based on key operations of a user. The input section 164 may further be one equipped with a pointing device such as a mouse or a touch panel, and other input apparatuses such as a bar code reader, a note pad, a scanner and OCR apparatuses.

Specifically, the input section 164 is used when a user instructs through photographing or regular photographing, namely, when preview image photographing or regular image photographing is instructed.

As shown in FIG. 1, control section 165 is provided, for example, with CPU 1651, RAM 1652 and ROM 1653.

CPU 1651 conducts various types of control operations in accordance with various types of processing programs for controller 16 stored in ROM 1653.

RAM 1652 is provided with a program storage area where processing programs to be practiced are developed and with a data storage area where inputted data and processing results generated when the aforesaid processing programs are practiced are stored.

ROM 1653 stores system programs which are practicable in control section 16, various types of processing programs which are practicable with the system programs, data used when these various types of processing programs are practiced and data representing the results of arithmetic processing by CPU 1651. Incidentally, the programs are stored in ROM 1653 in a form of a program code which can be read by a computer.

Concretely, in ROM 1653, there are stored, for example, preview image photographing control program 1653a and regular image photographing control program 1653b as shown in FIG. 1.

When preview image photographing is instructed by operations of input section 164 by a user, for example, preview image photographing control program 1653a causes communication section 161 to transmit “preview image photographing” to photographing apparatus 11, and then, causes buffer 162 to store preview image data obtained by preview image photographing based on the “preview image photographing” command which was transferred from photographing apparatus 11, and the preview image photographing control program 1653a causes CPU 1651 to realize a function to display the stored preview image data on the image display section 163.

Specifically, the occasion when preview image photographing is instructed by operations of input section 164 by a user means an occasion when, for example, the power of photographing apparatus 11 is instructed to be turned on.

When regular image photographing is instructed by operations of a user on the input section 164, for example, regular image photographing control program 1653b causes communication section 161 to transmit “regular image photographing” command to photographing apparatus 11, and causes CPU 1651 to realize a function to display preview image data (for example, latest preview image data stored in butter 162 in advance) obtained in advance on image display section 163.

Further, when regular image data by regular image photographing based on “regular image photographing” are obtained from photographing apparatus 11, for example, regular image photographing control program 1653b causes CPU 1651 to realize a function to change preview image data obtained in advance into the obtained regular image data to display on image display section 163.

In this case, when regular image data are displayed on image display section 163, for example, the CPU 1651 displays, through the prescribed display mode, that the displayed image data are regular image data.

Specifically, the CPU 1651 causes image display section 163, for example, to indicate a text display such as “These are Regular Images” or a designation which shows regular image data, together with the regular image data.

<Processing by Camera System>

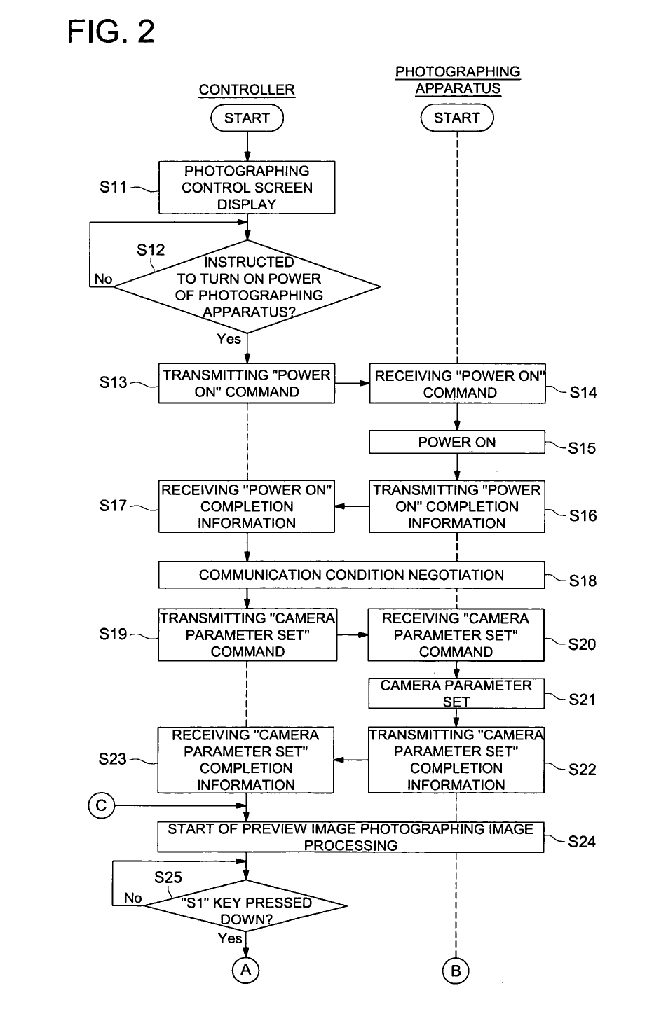

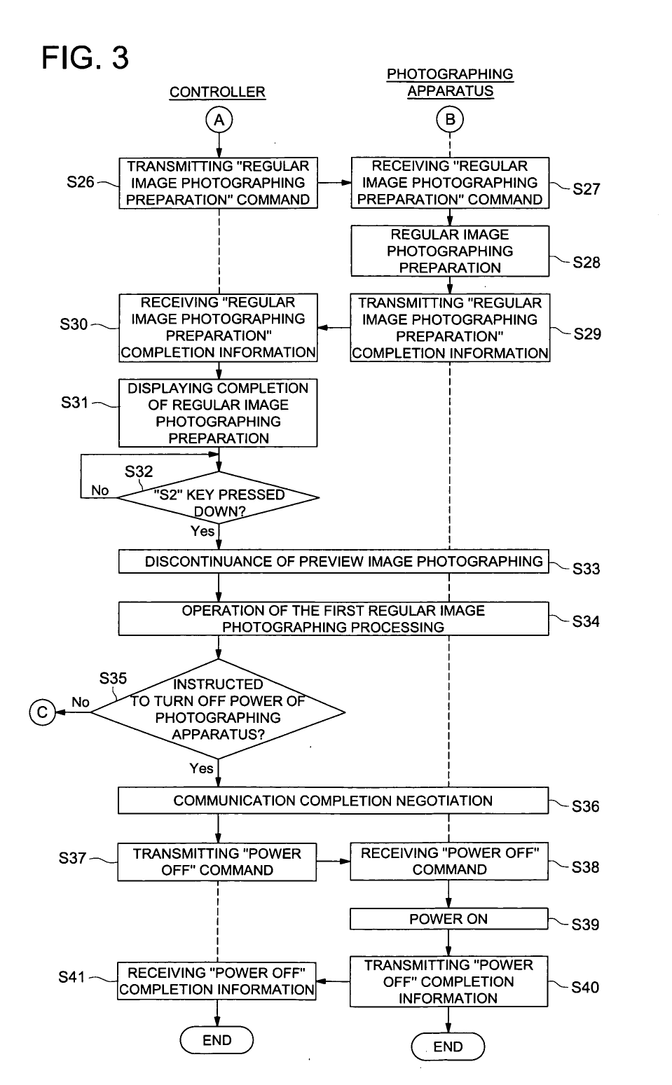

Next, processing conducted by camera system 1 will be explained as follows, referring to FIG. 2 and the flow chart in FIG. 3.

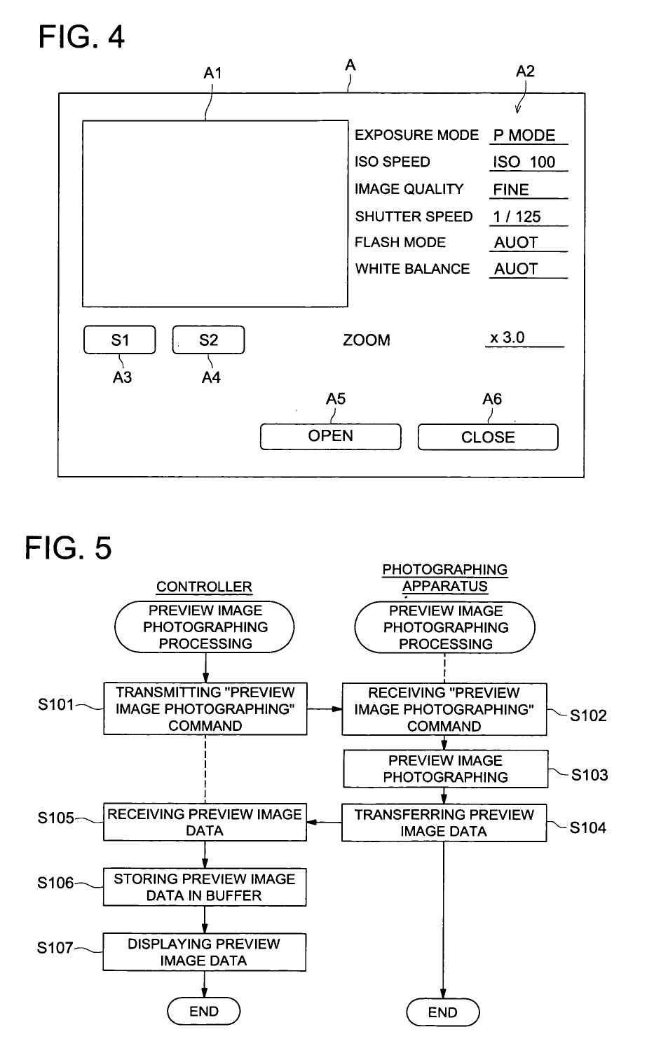

First, CPU 1651 of controller 16 displays, for example, photographing control screen A shown in FIG. 4, on image display section 163 (step S11).

On the photographing control screen A shown in FIG. 4, there are specifically displayed, for example, image display screen A1, camera parameter display column A2, “S1” key A3, “S2” key A4, “OPEN” key A5 and “CLOSE” key A6.

A camera parameter displayed on the camera parameter display column A2 can be rewritten to the parameter desired by a user, through, for example, user's operations on input section 164.

When giving an instruction for preparation of regular image photographing to photographing apparatus 11, for example, namely, when instructing photographing apparatus 11 to practice, for example, AE (Auto Exposure), AF (Auto Focusing) and AWB (Auto White Balance) specifically, “S1” key A3 is depressed by user's operations on input section 164.

When giving an instruction for regular image photographing to photographing apparatus 11, for example, “S2” key A4 is depressed by user's operations on input section 164.

Then, CPU 1651 judges whether or not “OPEN” key A5 shown on photographing control screen A (FIG. 4) is depressed by, for example, user's operations on input section 164, namely, it judges whether the power for photographing apparatus 11 is instructed to be turned on or not (step S12).

In step S12, if the power for photographing apparatus 11 is judged not to be turned on (step S12; No), CPU 1651 repeats processing in step S12.

On the other hand, when the power for photographing apparatus 11 is judged to be instructed to be turned on in step S12 (step S12; Yes), CPU 1651 causes communication section 161 of controller 16 to transmit “Power ON” command to photographing apparatus 11 (step S13).

When communication section 112 of photographing apparatus 11 receives “Power ON” command transmitted in step S13 (step S14), CPU 1141 of photographing apparatus 11 turns on the power for photographing apparatus 11 in accordance with the received “Power ON” command (step S15), and causes communication section 112 to transmit “Power ON” completion information to photographing apparatus 16 (step S16).

When communication section 161 of controller 16 receives “Power ON” completion information transmitted in step S16 (step S17), CPU 1651 of controller 16 causes communication section 161 and communication section 112 of photographing apparatus 11 to practice communication condition negotiation between them (step S18).

When the communication condition negotiation in step S18 is completed, CPU 1651 of controller 16 causes communication section 161 of controller 16 to transmit to photographing apparatus 11 the camera parameter displayed on camera parameter display column A2 of photographing control screen A (FIG. 4) and “camera parameter set” command (step S19).

When communication section 112 of photographing apparatus 11 receives a camera parameter and “camera parameter set” command transmitted in step S19 (step S20), CPU 1141 of photographing apparatus 11 sets camera parameter of photographing apparatus 11 based on the camera parameter thus received, in accordance with the “camera parameter set” thus received (step S21), and causes the communication section 112 to transmit “camera parameter set” completion information to controller 16 (step S22).

After the communication section 161 of controller 16 receives “camera parameter set” completion information transmitted in step S22 (step S23), CPU 1651 of controller 16 starts preview image photographing processing (FIG. 5) which will be explained later (step S24).

Then, CPU 1651 judges whether “S1” key A3 displayed on photographing control screen A (FIG. 4) has been depressed by user's operations on input section 164 or not (step S25).

In step S25, if “S1” key A3 is judged not to have been depressed (step S25; No), CPU 1651 repeats processing to be conducted in step S25.

In step S25, on the other hand, if “S1” key A3 is judged to have been depressed (step S25; Yes), CPU 1651 causes communication section 161 of controller 16 to transmit “regular image photographing preparation” command to photographing apparatus 11 (step S26).

After the communication section 112 of photographing apparatus 11 receives “regular image photographing preparation” command transmitted in step S26 (step S27), CPU 1141 of photographing apparatus 11 conducts preparation for regular image photographing (step S28) in accordance with the “regular image photographing preparation” command thus received (step S28), and causes communication section 112 to transmit “regular image photographing preparation” completion information to controller 16 (step S29).

After communication section 161 of controller 16 receives “regular image photographing preparation” completion information transmitted in step S29 (step S30), CPU 1651 of controller 16 causes a prescribed portion of photographing control screen A (FIG. 4) to display that preparation for regular image photographing has been completed (for example, text display such as “Photographing is ready” (step S31).

Then, CPU 1651 judges whether “S2” key A4 displayed on photographing control screen A (FIG. 4) has been depressed by user's operations on input section 164 or not (step S32).

In step S32, if “S2” key A4 is judged not to have been depressed (step S32; No), CPU 1651 repeats processing to be conducted in step S32.

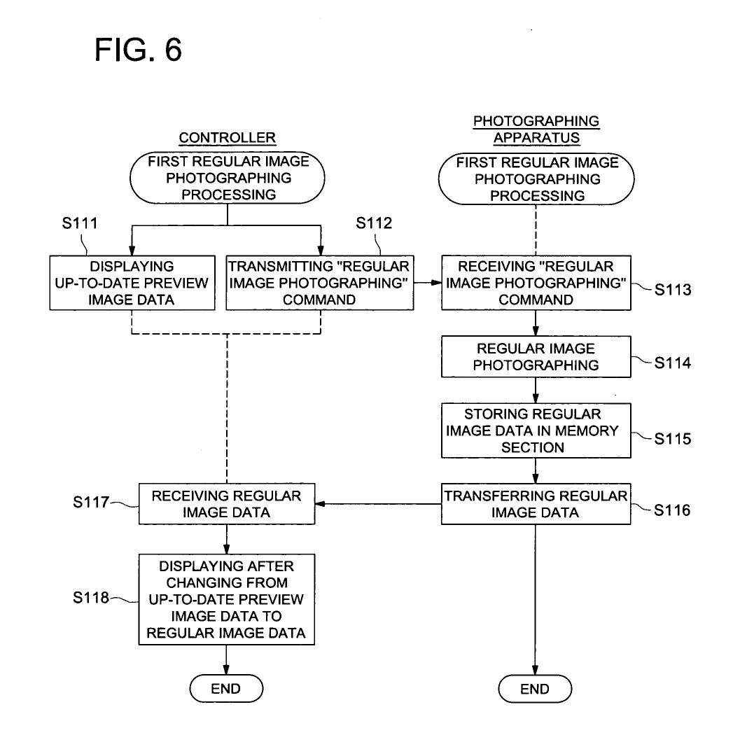

In step S32, on the other hand, if “S2” key A4 is judged to have been depressed (step S32; Yes), CPU 1651 stops preview image photographing processing (FIG. 5) started in step S24 (step S33), and carries out first regular image photographing processing (FIG. 6) which will be explained later (step S34).

Then, CPU 1651 judges whether “CLOSE” key A6 displayed on photographing control screen A (FIG. 4) by user's operations on input section 164, for example, has been depressed or not, namely, whether the power for photographing apparatus 11 has been instructed to be turned off or not (step S35).

In step S35, if the power for photographing apparatus 11 is judged not to have been instructed to be turned off (step S35; No), CPU 1651 repeats processing to be conducted in step S24 and thereafter.

In step S35, on the other hand, if the power for photographing apparatus 11 is judged to have been instructed to be turned off (step S35; Yes), CPU 1651 causes communication completion negotiation to be conducted between communication section 161 and communication section 112 of photographing apparatus 11 (step S36).

After the communication completion negotiation has been completed in step S36, CPU 1651 of controller 16 causes communication section 161 of controller to transmit a “Power OFF” command to photographing apparatus 11 (step S37).

After communication section 112 of photographing apparatus 11 receives “Power OFF” command transmitted in step S37 (step S38), CPU 1141 of photographing apparatus 11 turns off the power for photographing apparatus 11 in accordance with the received “Power OFF” command (step S39), and causes communication section 112 to transmit “Power OFF” completion information to controller 16 (step S40) to complete the present processing.

Then, when communication section 161 of controller 16 receives “Power OFF” completion information transmitted in step S40 (step S41), CPU 1651 of controller 16 terminates the present processing.

(Preview Image Photographing Processing)

Processing concerning preview image photographing by camera system 1 will be explained as follows, referring to the flow chart shown in FIG. 5.

First, CPU 1651 of controller 16 executes preview image photographing control program 1653a, and causes communication section 161 of controller 16 to transmit “preview image photographing” command to photographing apparatus 11 (step S101).

After communication section 112 of photographing apparatus 11 receives “preview image photographing” command transmitted in step S101 (step S102), CPU 1141 of photographing apparatus 11 causes photographing section 111 to execute preview image photographing in accordance with the received “preview image photographing” command (step S103), and causes communication section 112 to transfer preview image data obtained by the preview image photographing to controller 16 (step S104) to complete the present processing.

After communication section 161 of controller 16 receives preview image data transferred in step S104 (step S105), CPU 1651 of controller 16 causes buffer 162 to store the received preview image data (step S106), and displays preview image data stored in buffer 162 on image display screen A1 of photographing control screen A (FIG. 4) displayed on image display section 163 (step S107) to complete the present processing.

(First Regular Image Photographing Processing)

Next, processing concerning regular image photographing by camera system 1 will be explained as follows, referring to the flow chart in FIG. 6.

First, CPU 1651 of controller 16 executes regular image photographing control program 1653a, then, displays latest preview image data stored in buffer 162 on image display screen A1 of photographing control screen A (FIG. 4) shown on image display section 163 (step S111), and causes communication section 161 of controller 16 to transmit “regular image photographing” command to photographing apparatus 11 (step S112).

After communication section 112 of photographing apparatus 11 receives “regular image photographing” command transmitted in step S112 (step S113), CPU 1141 of photographing apparatus 11 causes photographing section 111 to execute regular image photographing in accordance with the received “regular image photographing” command (step S114), then, causes memory section 113 to store regular image data obtained through the regular image photographing (step S115) and causes communication section 112 to transfer regular image data obtained through the regular image photographing (step S116) to terminate the present processing.

Then, after communication section 161 of controller 16 receives regular image data transmitted in step S116 (step S117), CPU 1651 of controller 16 changes from latest preview image data stored in buffer 162 displayed in step S111 to the received regular image data to display on image display screen A1 of photographing control screen A (FIG. 4) shown on image display section 163 (step S118), and displays that the displayed image data are regular image data on a prescribed portion of photographing control screen A (FIG. 4), in a prescribed display mode (for example, text display such as “These are regular images”), to terminate the present processing.

In camera system 1 in the first embodiment explained above, when regular image photographing is instructed, it is possible to display preview image data which are obtained in advance (namely, stored in buffer 162 in advance) on image display section 163. Namely, when regular image photographing is instructed, it is possible to display, for example, latest preview image data obtained immediately before the instruction, on image display section 163. Therefore, an image which can be confirmed on the controller 16 side is not regular image itself, but is an image which is substantially the same as a regular image, whereby, an effect that is substantially the same as that in the case where the regular image itself is confirmed can be obtained, and when confirming the image taken by photographing apparatus 11 on the controller 16 side, the image can be confirmed rapidly, which is convenient for a user.

Further, if regular image data are obtained, it is possible to change image data displayed on image display section 163 from preview image data obtained in advance into the obtained regular image data. Therefore, the regular image itself can be confirmed, thus, it is possible to confirm not only rapidly but also accurately, which is more convenient for a user.

It is further possible to display that the displayed image data are regular image data, when image data shown on image display section 163 are changed to regular image data. Accordingly, it is possible to discriminate surly whether image data shown on image display section 163 are preview image data or regular image data, which is convenient for a user.

### Second Embodiment

Next, camera system 2 in the second embodiment will be explained.

<Structure of Camera System>

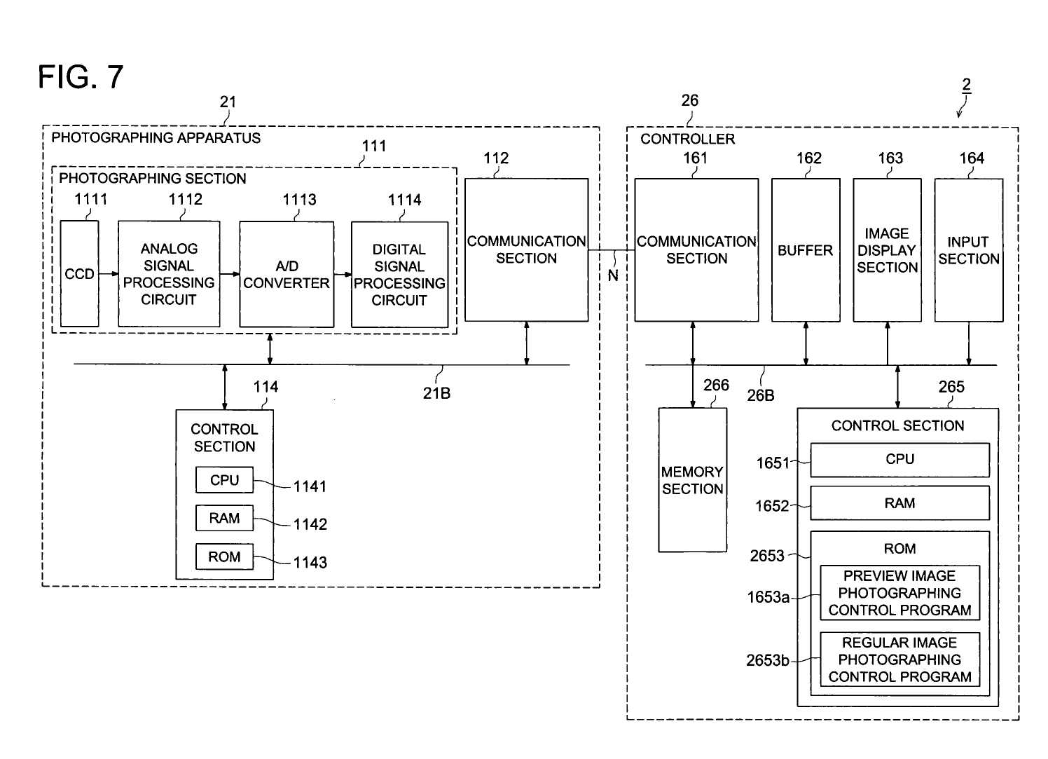

First, the structure of camera system 2 will be explained by reference to FIG. 7.

The camera system 2 of the second embodiment is different from camera system 1 (FIG. 1) of the first embodiment in terms of an only point that regular image data are stored on the controller side. Specifically, a part of the structure of photographing apparatus 11 (FIG. 1), a part of the structure of controller 16 (FIG. 1) and a part of the structure of control section 165 in controller 16 (FIG. 1) are different. Accordingly, different points only will be explained, and other common portions are given the same symbols to be explained.

Camera system 2 is composed, for example, of photographing apparatus 21 and controller 26 which are connected to each other through communication network N as shown in FIG. 7.

<Structure of Photographing Apparatus>

Photographing apparatus 21 is composed, for example, of photographing section 111, communication section 112 and control section 114 as shown in FIG. 7. Respective portions are connected each other through bus 21B.

<Structure of Controller>

Controller 26 is composed, for example, of communication section 161, buffer 162, image display section 163, input section 164, control section 265 and memory section 266 as shown in FIG. 7. Respective sections are connected each other through bus 26B.

Control section 265 is composed, for example, of CPU 1651, RAM 1652 and ROM 2653 as shown in FIG. 7.

ROM 2653 stores system programs practicable on controller 26, various types of processing programs practicable with the system programs, data used in practicing these various types of processing programs and data of processing results computed by CPU 1651. Incidentally, programs are stored in ROM 2653 in a form of a program code readable for a computer.

Specifically, preview image photographing control program 1653a and regular image photographing control program 2653b, for example, are stored in ROM 2653 as shown in FIG. 7.

When regular image photographing is instructed by user's operations on input section 164, for example, regular image photographing control program 2653b causes communication section 161 to transmit “regular image photographing” command to photographing apparatus 21, then, displays preview image data obtained in advance (for example, latest preview image data stored in buffer 162 in advance) on image display section 163, and after that, the regular image photographing control program 2653b causes CPU 1651 to realize a function to cause memory section 266 to store regular image data obtained by regular image photographing based on the “regular image photographing” command transferred from photographing apparatus 21.

Further, if regular image data by regular image photographing based on “regular image photographing” command are obtained from photographing apparatus 21, for example, regular image photographing control program 2653b changes from preview image data obtained in advance to the obtained regular image data, and causes CPU 1651 to realize a function to display on image display section 163.

In this case, when displaying regular image data on image display section 163, for example, the CPU 1651 is supposed to indicate that the displayed image data are regular image data, through the prescribed display mode.

Memory section 266 is composed, for example, of a magnetic memory medium, an optical memory medium or a semiconductor memory.

The memory section 266 stores regular image data obtained through regular image photographing by photographing apparatus 21, in accordance with, for example, an instruction coming from control section 265.

<Processing by Camera System>

Next, processing by camera system 2 will be explained.

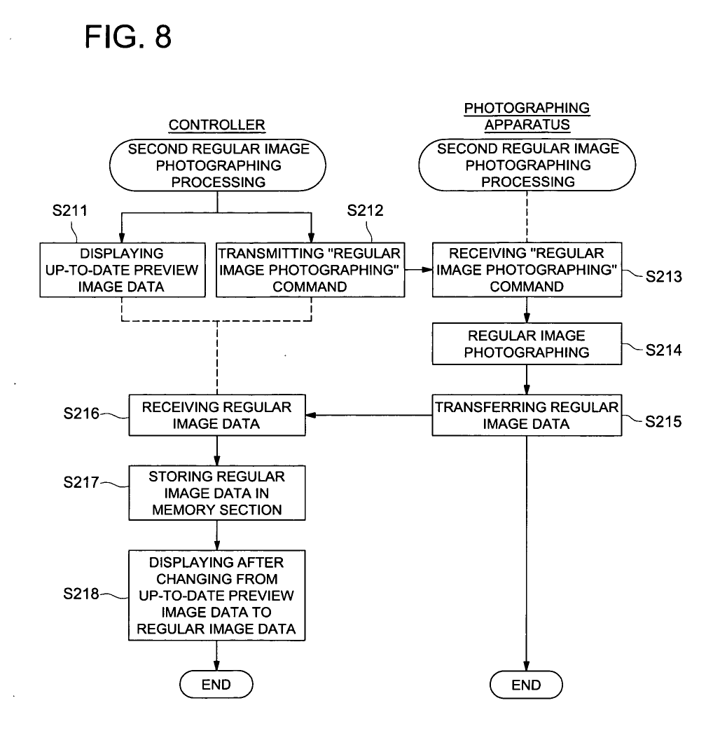

Incidentally, with respect to processing by camera system 2, only regular image processing is different from processing by camera system 1 (FIG. 2 and FIG. 3). Specifically, the processing by camera system 2 is different from processing by camera system 1 (FIG. 2 and FIG. 3) in terms of only point that the second regular image processing (FIG. 8) which will be described later is practiced in step S34 of processing by camera system 1 (FIG. 2 and FIG. 3). Therefore, a different point only will be explained.

(Second Regular Image Photographing Processing)

Processing concerning regular image photographing by camera system 2 will be explained as follows, referring to the flow chart in FIG. 8.

First, CPU 1651 of controller 26 carries out regular image photographing control program 2653b, then, displays latest preview image data stored in buffer 162 on image display screen A1 of photographing control screen A (FIG. 4) shown on image display section 163 (step S211), and causes communication section 161 of controller 26 to transmit “regular image photographing” command to photographing apparatus 21 (step S212).

After communication section 112 of photographing apparatus 21 receives “regular image photographing” command transmitted in step S212 (step S213), CPU 1141 of photographing apparatus 21 causes photographing section 111 to practice regular image photographing in accordance with the received “regular image photographing” command (step S214) and causes communication section 112 to transfer regular image data obtained by the regular image photographing to controller 26 (step S215), to terminate the present processing.

Then, after communication section 161 of controller 26 receives regular image data transferred in step S215 (step S216), CPU 1651 of controller 26 causes memory section 266 to store the received regular image data (step S217).

Then, CPU 1651 changes from latest preview image data stored in buffer 162 displayed in step S211 to the regular image data received in step S216 to display on image display screen A1 of photographing control screen A (FIG. 4) shown on image display section 163 (step S218), and displays that the displayed image data are regular image data on the prescribed portion of photographing control screen A (FIG. 4) through the prescribed display mode, to terminate the present processing.

In the camera system 2 in the second embodiment explained above, regular image data are stored on the controller 26 side, and therefore, processing of editing the regular image data becomes easy, which is convenient for a user.

### Third Embodiment

Next, camera system 3 in the third embodiment will be explained.

<Structure of Camera System>

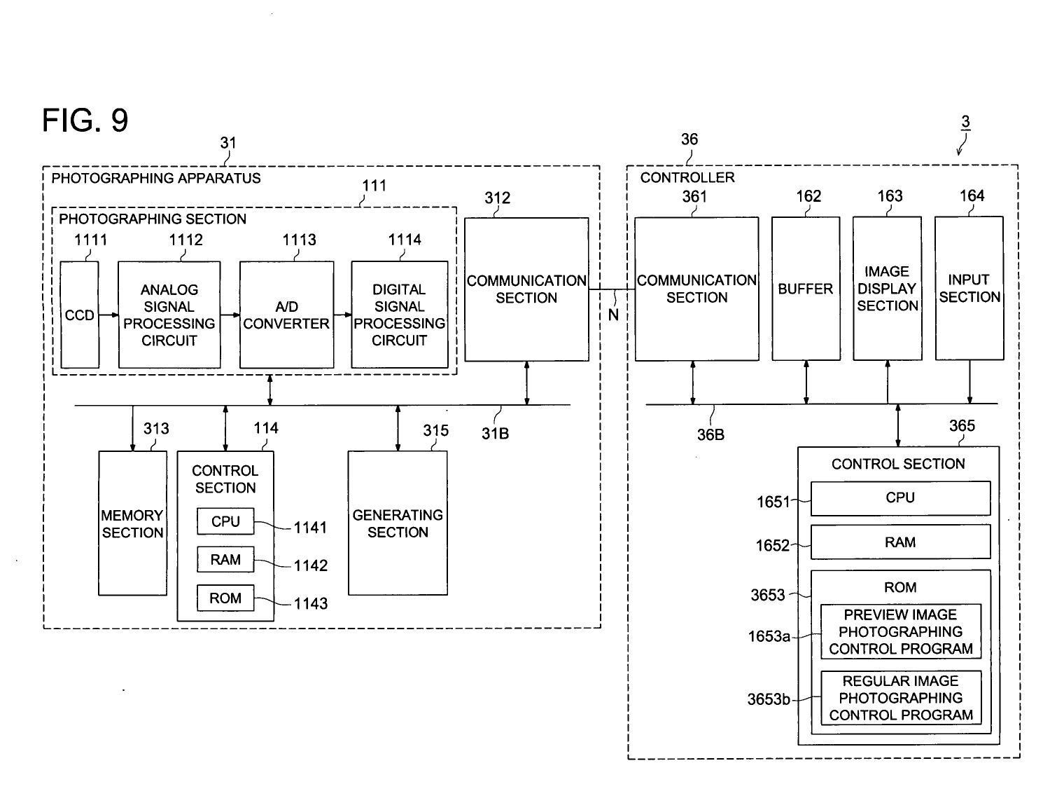

First, the structure of camera system 3 will be explained as follows, referring to FIG. 9.

Meanwhile, camera system 3 in the third embodiment is different from camera system 1 in the first embodiment (FIG. 1) in terms of only point that regular image data to be transferred to a controller from a photographing apparatus are of low resolution. To be concrete, a part of the structure of photographing apparatus 11 (FIG. 1), a part of the structure of photographing apparatus 11 (FIG. 1), a part of the structure of communication section 112 and memory section 113 in photographing apparatus 11 (FIG. 1) and a part of the structure of communication section 161 and control section 165 in controller 16 (FIG. 1) are different. Accordingly, different points only will be explained, and other common portions are given the same symbols to be explained.

The camera system 3 is composed, for example, of photographing apparatus 31 and controller 36 which are connected to each other through communication network N, as shown in FIG. 9.

<Structure of Photographing Apparatus>

Photographing apparatus 31 is provided, for example, with photographing section 111, communication section 312, memory section 313, control section 114 and generating section 315, as shown in FIG. 9. Respective portions are connected to each other through bus 31B.

Communication section 312 is connected with communication section 361 (described later) of controller 36 through communication network N, and it conducts transmitting and receiving for various types of information between itself and controller 36.

Specifically, the communication section 312 receives, for example, a prescribed control command coming from controller 36.

Further, the communication section 312 transfers preview image data obtained by though image photographing of photographing section 111 to controller 36, in accordance with, for example, an instruction from control section 114 based on “preview image photographing” command coming from controller 36.

In addition, the communication section 312 transfers low resolution image data (described later) of regular images generated by generating section 315, in accordance with, for example, an instruction from control section 114 based on “regular image photographing” command coming from controller 36.

Memory section 313 is composed, for example, of a magnetic memory medium, an optical memory medium or a semiconductor memory.

The memory section 313 stores Exif (Exchangeable Image File Format) file (described later) of regular images generated by generating section 315 from regular image data obtained by regular image photographing of photographing section 111, in accordance with, for example, an instruction from control section 114 based on “regular image photographing” command from controller 36.

Generating section 315 generates regular image data in a prescribed file format (for example, Exif file of regular images) from regular image data obtained by regular image photographing of photographing section 111, in accordance, for example, with an instruction from control section 114 based on “regular image photographing” command from controller 36.

In this case, Exif file of regular images generated by generating section 315 includes, for example, regular image data and low resolution image data (for example, thumb-nail images) lower than the regular image data in terms of resolution. Namely, the generating section 315 can generate low resolution image data of regular images from regular image data obtained through regular image photographing by photographing section 111, in accordance with an instruction from control section 114 based on #regular image photographing” command from controller 36.

<Structure of Controller>

Controller 36 is provided with, for example, communication section 361, buffer 162, image display section 163, input section 164 and control section 365, as shown in FIG. 9. Respective sections are connected to each other through bus 36B.

Communication section 361 is connected with communication section 312 of photographing apparatus 31 through communication network N, and it conducts transmitting and receiving for various types of information between itself and photographing apparatus 31.

Specifically, communication section 361 transmits a prescribed control command to photographing apparatus 31, in accordance with an instruction from, for example, control section 365.

Further, the communication section 361 receives, for example, preview image data or low resolution image data of regular images transferred from photographing apparatus 31.

The control section 365 is provided with, for example, CPU 1651, RAM 1652 and ROM 3653, as shown in FIG. 9.

ROM 3653 stores system programs practicable on controller 36, various types of processing programs practicable with the system programs, data used in practicing these various types of processing programs and data of processing results computed by CPU 1651. Incidentally, programs are stored in ROM 3653 in a form of a program code readable for a computer.

Specifically, preview image photographing control program 1653a and regular image photographing control program 3653b, for example, are stored in ROM 3653 as shown in FIG. 9.

When regular image photographing is instructed by user's operations on input section 164, for example, regular image photographing control program 3653b causes communication section 361 to transmit “regular image photographing” command to photographing apparatus 31, and then, causes CPU 1651 to realize a function to display low resolution image data of regular images obtained by regular image photographing based on the “regular image photographing” command transferred from photographing apparatus 31 on image display section 163.

In this case, when displaying low resolution image data of regular images on image display section 163, for example, the CPU 1651 is supposed to indicate that the displayed low resolution image data are regular image data, through the prescribed display mode.

Specifically, CPU 1651 causes, for example, image display section 163 to display text display such as “these are regular images” and symbol display which tells that these are generated from regular image data, together with low resolution image data of regular images.

<Processing by Camera System>

Next, processing by camera system 3 will be explained.

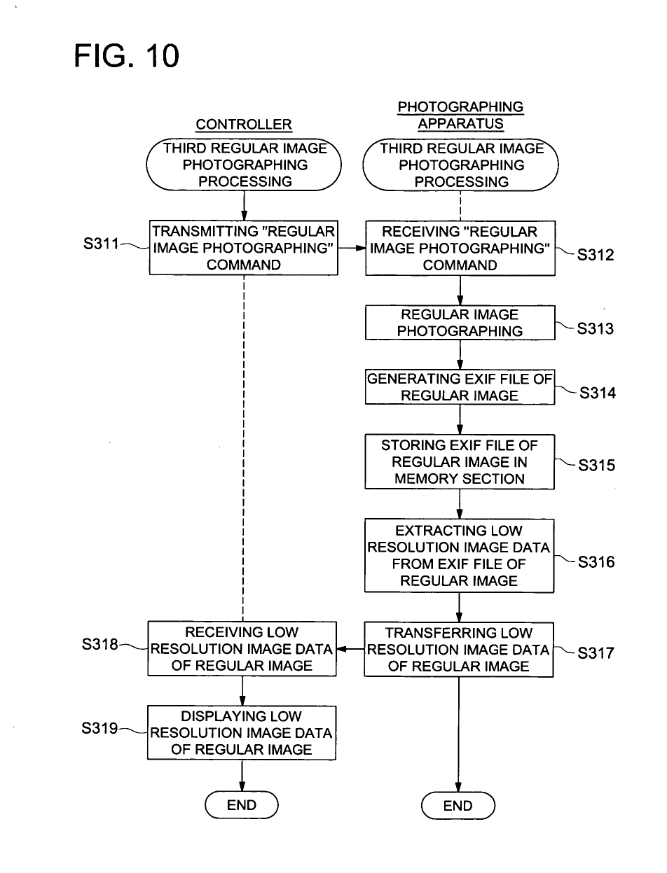

Incidentally, with respect to processing by camera system 3, only regular image processing is different from processing by camera system 1 (FIG. 2 and FIG. 3). Specifically, the processing by camera system 3 is different from processing by camera system 1 (FIG. 2 and FIG. 3) in terms of only point that the third regular image processing (FIG. 10) which will be described later is practiced in step S34 of processing by camera system 1 (FIG. 2 and FIG. 3). Therefore, a different point only will be explained.

(Third Regular Image Photographing Processing)

Processing concerning regular image photographing by camera system 3 will be explained as follows, referring to the flow chart in FIG. 10.

First, CPU 1651 of controller 36 carries out regular image photographing control program 2653b, and causes communication section 361 of controller 36 to transmit “regular image photographing” command to photographing apparatus 31 (step S311).

After communication section 312 of photographing apparatus 31 receives “regular image photographing” command transmitted in step S311 (step S312), CPU 1141 of photographing apparatus 31 causes photographing section 111 to practice regular image photographing in accordance with the received “regular image photographing” command (step S313), then, causes generating section 315 to generate Exif file of regular images from regular image data obtained by the regular image photographing (step S314), then, causes memory section 313 to store the generated Exif file of regular images (step S315), then, extracts low resolution image data of regular images from the generated Exif file of regular images (step S316), and causes communication section 312 to transfer the extracted low resolution image data of regular images to controller 36 (step S317), to terminate the present processing.

Then, after communication section 361 of controller 36 receives low resolution image data of regular images transferred in step S317 (step S318), CPU 1651 of controller 36 causes the received low resolution image data of regular images to be displayed on image display screen A1 of photographing control screen A (FIG. 4) shown on image display section 163 (step S319), and makes that the displayed image data are those generated from regular image data to be displayed on a prescribed portion of photographing control screen A (FIG. 4) through the prescribed display mode, to terminate the present processing.

In camera system 3 in the third embodiment explained above, when regular image photographing is instructed, it is possible to display low resolution image data of regular images generated on the photographing apparatus 31 side. Namely, since low resolution image data of regular images to be displayed on image display section 163 is less than regular image data in terms of data amount, they can be displayed more rapidly than regular image data, whereby, when confirming the image taken on photographing apparatus 31 on the controller 36 side, the confirmation can be carried out rapidly, which is convenient for a user.

Further, when displaying low resolution image data of regular images on image display section 163, it is possible to display that the image data are those generated from regular image data. Therefore, it is possible to judge surely whether image data shown on image display section 163 are preview image data or data generated from regular image data, which is convenient for a user.

Memory section 113 is provided on photographing apparatus 11 in the first embodiment, memory section 266 is provided on controller 26 in the second embodiment and memory section 313 is provided on photographing apparatus 31 in the third embodiment. Namely, a memory section to store regular image data and a photographing apparatus are united solidly as one body, or a memory section to store regular image data and a controller are united solidly as one body. However, the memory section and the photographing apparatus may also be separate each other, or the memory section and the controller may also be separate each other.

Though the latest preview image data obtained in advance are displayed when regular image photographing is instructed in the first embodiment, image data to be displayed when regular image photographing is instructed may be optional, provided that they are preview image data obtained in advance (namely, those stored in buffer 162 in advance).

The same may apply also to the second embodiment.

Though regular image data are transferred from photographing apparatus 11 to controller 16 in the first embodiment, regular image data do not always need to be transferred to controller 16. When the regular image data are not transferred to controller 16, the regular image data are not naturally displayed on image display section 163.

Though regular image data are stored and displayed on the controller 16 side in the second embodiment, the regular image data have only to be stored on the controller 16, side to say the least.

Though regular image data are stored in memory section 113 of photographing apparatus 11 in the first embodiment, the invention is not limited to this, and it is also possible to arrange so that Exif file of regular images may be generated from regular image data on the photographing apparatus 11 side, for example, and thereby the generated Exif file of regular images may be stored in the memory section 113.

Further, though regular image data are stored in memory section 226 of controller 26 in the second embodiment, the invention is not limited to this, and it is also possible to arrange so that Exif file of regular images may be generated from regular image data on the photographing apparatus 21 side or on the controller 26 side, for example, and thereby the generated Exif file of regular images may be stored in the memory section 266.

Though Exif file of regular images can be generated in generating section 315 in the third embodiment, the generating section 315 has only to be capable of generating, from at least regular image data, low resolution image data which are lower than the regular image data in terms of resolving power, and it is not always necessary to generate Exif file of regular images. When low resolution image data of regular images only are generated by generating section 315, and Exif file of regular images is not generated, regular image data are stored in memory section 313 of photographing apparatus 31, in the same way as in memory section 113 of the first embodiment.

In the first embodiment, photographing apparatus 11 and controller 16 may also be connected directly each other through a cable (for example, USB (Universal Serial Bus) cable) representing a communication means, for example, without being connected through communication network N representing a communication means.

The same applies to the second embodiment and the third embodiment.

What is claimed is:

1. A camera system to photograph a subject as a preview photography and as a regular photography, and to display image of the preview photography and image of the regular photography, comprising:
a communication section;
a photographing section to photograph the subject;
a control section to control the photographing section through the communication section, at least to photograph the subject as the preview photography;
a memory section to store image data as the regular photography and as the preview photography of the subject, photographed by the photographing section; and
an image display section, provided on the control section, wherein when the control section controls the photographing section to photograph the subject as the regular photography after the preview photography, the image display section displays the preview photography of the subject based on the image data which was previously stored in the memory section.

2. The camera system claim 2, wherein the memory-section is provided on the photographing section.

3. The camera system in claim 1, wherein the memory section is provided on the control section.

4. The camera system in claim 1, wherein when the control section controls the photographing section to photograph the regular photography, the image display section changes to display the image data of the preview photography which was previously photographed to the image data of the regular photography.

5. The camera system in claim 4, wherein when the image display section displays the image of the regular photography, the control section controls the image display section to display through a prescribed display mode that the image displayed on the image display section is the image of the regular photography.

6. A camera system to photograph a subject as a preview photography and as a regular photography, and to display the image of the preview photography and the image of the regular photography, comprising:
a communication section;
a photographing section which photographs the subject as the regular photography and as the preview photography, and has a generating section to produce image data having lower resolution than the regular photography, from image data of the regular photography;
a control section to control the photographing section through the communication section, to photograph the subject as the regular photography, or to photograph the subject as the preview photography;
a memory section to store image data as the preview photography and the regular photography of the subject, photographed by the photographing section; and
an image display section wherein when the control section controls the photographing section to photograph the subject as the regular photography after the preview photography, the image display section generates the image of the subject whose resolution is lower than the regular photography in the generating section, and displays lower resolution image.

7. The camera system in claim 6, wherein when the image display section displays the low resolution image, the control section controls the image display section to display through a prescribed display mode that the displayed low resolution image is generated from the regular image data.

8. A control device connected to a photographing device which photographs a subject as a preview photography and as a regular photography, comprising:
a communication section;
a control section to control the photographing device through the communication section, to photograph the subject as the regular photography, or to photograph the subject as the preview photography;
an image display section to display at least the image of the subject photographed as the preview photography, controlled by the control section, and when the control device controls the photographing device to photograph the subject as the regular photography, the image display section displays the preview photography which was previously photographed.

9. The control device in claim 8, further comprising a memory section to store the image data of the regular image photography.

10. The control device in claim 8, wherein in a case that the control device controls the photographing device to photograph the subject as the regular image photography, after the regular image data is obtained by the photographing device, the control section controls the image display section to display through a prescribed display mode that the image data displayed on the image display section is the image data of the regular photography.

11. The control device in claim 10, wherein when the image display section displays the regular image data, the control section controls the image display section to display through a prescribed display mode, that the displayed image data is the image data of the regular photography.

12. A control device connected to a photographing device which photographs a subject as a preview photography and as a regular photography, comprising:
a communication section;
a control section to control a photographing section to photograph a subject as a preview photography or a regular photography; and
an image display section to display the image of the preview photography controlled by the control section, and when the control section controls the photographing device to photograph the subject as the regular photography, the image display section displays a photography whose resolution is changed lower than the regular photography based on the image data of the regular photography.

13. The control device in claim 12, wherein when the image display section displays the regular image data, the display device displays through a prescribed display mode that the displayed low resolution image is generated from the image data of the regular photography.
